(19) United States
(12) Patent Application Publication
(10) Pub. No.: US 2005/0275738 A1
(43) Pub. Date: Dec. 15, 2005

(54) Digital camera and cleaning apparatus therefor

(75) Inventor: Akihiro Arai, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/143,603

(22) Filed: Jun. 3, 2005

(30) Foreign Application Priority Data
Jun. 10, 2004 (JP) 2004-172043

(51) Int. Cl. H04N 5/225

(52) U.S. Cl. 348/335

(57) ABSTRACT

A digital camera, which an interchangeable lens system allowing a plurality of lenses to be selectively and detachably attached to a lens mount provided to a camera body, is configured such that an object image is captured by an image sensor. The camera is provided with a plurality of movable members which are arranged between the lens mount and the image capturing area of the image sensor. The plurality of movable members move when an image is captured. The camera is further provided with an operable member allowing a user to select one of a plurality of operation modes. The plurality of operation modes include at least a cleaning mode. The movable members are retracted from a path from the lens mount to the image sensor to allow an access to the image sensor from the lens mount when the cleaning mode is selected.

### BACKGROUND OF THE INVENTION

The present invention relates to a digital camera employing an exchangeable lens system, such as a digital SLR (single-lens reflex) camera, and particularly to a structure and/or apparatus for removing dust or minute particles invaded inside a body of such a digital camera.

A digital SLR camera is configured such that various types of lenses can be exchangeably attached to a camera body. For this purpose, a lens mount is formed on the camera body. When a lens is detached from the camera body (i.e., the lens mount), the interior of the camera body is exposed to the open air through an opening of the lens mount, and dirt and/or dust may readily enter the camera body through the opening. The dirt and/or dust entered through the opening typically adheres onto a quick return mirror (i.e., a movable mirror) and/or a focusing glass. Such dirt and/or dust can easily be removed with a device such as a blower, which is inserted through the opening of the lens mount. However, some portion of the dust passes through a shutter that opens at the time of release, and adheres to an image capturing area of an image sensor such as a CCD (Charge Coupled Device) or a CMOS (Complementary Metal Oxide Semiconductor). The dirt and/or dust interferes with the image of the object in reaching to the image sensor, and causes partial lack of image represented by the image signals, which is output by the image sensor. With regard to general digital cameras, an image sensor is often configured as a unit where its image capturing area is protected by a cover glass. Even in such a case, the above-described problem may occur. Therefore, in the specification, a term “an image capturing area of an image sensor” includes an image capturing unit which is defined as an image sensor provided with the cover glass in front of the image capturing area thereof.

In order to prevent the partial lack of images caused by the dirt and/or dust adhered to the image capturing area of the image sensor, various methods/structures have been suggested. An example of a dust-proof structure is disclosed in Japanese Patent Publication No. 3520914. The publication discloses a dust-protective casing that prevents dirt and/or dust from adhering to the image capturing area of the image sensor. A wall in front of the image capturing area of the image sensor is located at a defocused position so that the dirt and/or dust adhered on the dust-protective casing does not substantially cause the lack of part of the image on the image capturing area.

Another example of the dust-proof structure is disclosed in United States Patent Application Publication No. 2004/0047625 A1, the teachings of which are incorporated herein by reference. According to this publication, a dust-proof optical member is provided in front of the image capturing area of the image sensor, and a mechanism that vibrates the dust-proof optical member is implemented in order to remove the dirt and/or dust adhered on the dust-proof optical member.

The configuration described in Japanese Patent Publication No. 3520914 is rather effective when the amount or the size of the dirt and/or dust adhered to the dust-protective casing is sufficiently small. When the amount of the size is larger, however, the dirt and/or dust blocks light that forms an image on the image sensor, and its effect is not negligible. Furthermore, the publication does not provide fundamental measures to remove the dirt and/or dust invaded inside the camera body.

Regarding the art described in United States Patent Application Publication No. 2004/0047625 A1, the effectiveness of removing the dirt and/or dust is assumed to depend on the degree of vibration of the dust-protective optical member. If the amplitude is small, the effectiveness is assumed to be small, while the vibration is propagated to the entire camera and causes awkwardness if the amplitude is set too large. In addition, the publication does not disclose removing the dirt and/or dust that has penetrated inside the camera body, either. Therefore, according to this publication, the dirt and/or dust which is effectively prevented from adhering to the dust-protective optical member or effectively removed from the dust-protective optical member still remains inside the camera body. No fundamental cleaning measure is presented in the publication.

### SUMMARY OF THE INVENTION

The present invention is advantageous in that a digital camera and its cleaning apparatus are provided, with which the dirt and/or dust adhered to the image capturing area of the image sensor can be effectively removed therefrom and ejected outside the camera body.

According to an aspect of the present invention, there is provided a digital camera employing an interchangeable lens system allowing a plurality of lenses to be selectively and detachably attached to a lens mount provided to a camera body. The digital camera includes an image sensor that captures an optical image of an object formed by the lens attached to the camera body, a plurality of movable members being arranged between the lens mount, the plurality of movable members moving when an image is captured, an operable member allowing a user to select one of a plurality of operation modes of the digital camera, the plurality of operation modes including at least a cleaning mode, and a controller that drives the movable members to be retracted from a path from the lens mount to the image sensor to allow an access to the image sensor from the lens mount when the cleaning mode is selected by the operable member.

Optionally, the digital camera may be a digital single-lens reflex camera, and the movable members include a quick return mirror and a shutter. The controller automatically moves the quick return mirror to a lift-up position and maintains the shutter in an opened status when the cleaning mode is selected.

Further optionally, the camera body may be provided with electrodes that supply electrical power when the cleaning mode is selected.

According to another aspect of the invention, there is provided a cleaning apparatus that removes dirt and/or dust adhered to an image capturing area of an image sensor arranged inside a camera body, the camera body having a lens mount to which a plurality of exchangeable lenses are selectively and detachably mounted, the cleaning apparatus being detachably mounted on the lens mount, the cleaning apparatus is provided with a cleaning head having a front end surface that faces the image capturing area of the image sensor when the cleaning apparatus is mounted on the lens mount, an opening formed on the front end surface of the cleaning head, and an aspirator pipe connected to the opening formed on the front end surface of the cleaning head, the air being ejected from the camera body to outside through the aspirator pipe.

Optionally, the cleaning apparatus may further include an aspirating apparatus that aspirates the air inside the camera body through the aspirator pipe.

In a particular case, the aspirating apparatus may be an electrically operable apparatus, an electrical power being supplied to the aspirating apparatus from the camera body. Alternatively, the aspirating apparatus can be a non-electrically operable apparatus which is manually operated by a user.

Optionally, the front end surface may face the image capturing area of the image sensor with a minute gap there between.

Still optionally, the front end surface may have an area that is greater than the image capturing area of the image sensor.

Further optionally, the cleaning apparatus may further include a flange portion formed around the aspirator pipe, the flange portion contacting the lens mount when the cleaning apparatus is coupled to the camera body, the flange portion restricting an inserting amount of the cleaning head in the camera body.

The flange portion may be formed with at least one inlet opening that allows the air to be introduced inside the camera body, the cleaning apparatus including a filter that filters the air introduced from the at least one inlet opening, the air filtered by the filter being introduced in the camera body.

According to a further aspect of the invention, there is provided a digital camera system including a digital camera and a cleaning apparatus, the digital camera employing an interchangeable lens system allowing a plurality of lenses to be selectively and detachably attached to a lens mount provided to a camera body. The digital camera may include an image sensor that captures an optical image of an object formed by the lens attached to the camera body, a plurality of movable members being arranged between the lens mount, the plurality of movable members moving when an image is captured, an operable member allowing a user to select one of a plurality of operation modes of the digital camera, the plurality of operation modes including at least a cleaning mode, and a controller that drives the movable member to be retracted from a path from the lens mount to the image sensor to allow an access to the image sensor from the lens mount when the cleaning mode is selected by the operable member. Further, the cleaning apparatus includes a mounting mechanism that allows the cleaning apparatus to be mounted on the lens mount, a cleaning head having a front end surface that faces the image capturing area of the image sensor when the cleaning apparatus is mounted on the lens mount, an opening formed on the front end surface of the cleaning head, and an aspirator pipe connected to the opening formed on the front end surface of the cleaning head, the air being ejected from the camera body to outside through the aspirator pipe.

Optionally, the cleaning apparatus may further include an aspirating apparatus that aspirates the air inside the camera body through the aspirator pipe.

In a particular case, the aspirating apparatus is an electrically operable apparatus. In such a case, the camera body may be provided with first electrodes that supply electrical power when the cleaning mode is selected, while the aspirating apparatus may be provided with second electrodes which contact the electrodes provided to the camera body when the cleaning apparatus is mounted on the camera body, an electrical power being supplied to the aspirating apparatus from the camera body through the first and second electrodes.

Alternatively, the aspirating apparatus may be an non-electrically operable apparatus which is manually operated by a user.

Optionally, the front end surface may be positioned to face the image capturing area of the image sensor with a minute gap therebetween.

Further optionally, the front end surface may have an area that is greater than the image capturing area of the image sensor.

Still optionally, the cleaning apparatus may include a flange portion formed around the aspirator pipe, the flange portion contacting the lens mount when the cleaning apparatus is coupled to the camera body, the flange portion restricting an inserting amount of the cleaning head in the camera body.

Optionally, the flange portion may be formed with at least one inlet opening that allows the air to be introduced inside the camera body, the cleaning apparatus including a filter that filters the air introduced from the at least one inlet opening, the air filtered by the filter being introduced in the camera body.

### BRIEF DESCRIPTION OF THE ACCOMPANYING DRAWINGS

FIG. 1 is a perspective view of a camera body of a digital camera according to the present invention;

FIG. 2 is a cross-sectional side view of the camera body shown in FIG. 1;

FIG. 3 is a perspective view of a cleaning apparatus according to a first embodiment of the invention;

FIG. 4A is a cross-sectional side view of the cleaning apparatus shown in FIG. 3;

FIG. 4B is a cross-sectional view of the cleaning apparatus taken along line B-B in FIG. 4A;

FIG. 5 is a cross-sectional side view of the camera body to which the cleaning apparatus according to the first embodiment is attached;

FIG. 6 is a perspective view of a cleaning apparatus according to a second embodiment of the invention;

FIG. 7 is a cross-sectional side view of the camera body to which the cleaning apparatus according to the second embodiment is attached;

FIG. 8 shows a cross-sectional side view of an injection type aspiration apparatus to be used together with the cleaning apparatus according to the second embodiment; and

FIG. 9 shows a cross-sectional side view of a blower type aspiration apparatus to be used together with the cleaning apparatus according to the second embodiment.

### DETAILED DESCRIPTION OF THE EMBODIMENT

Referring to the accompanying drawings, first and second embodiments of the present invention will be described.

### First Embodiment

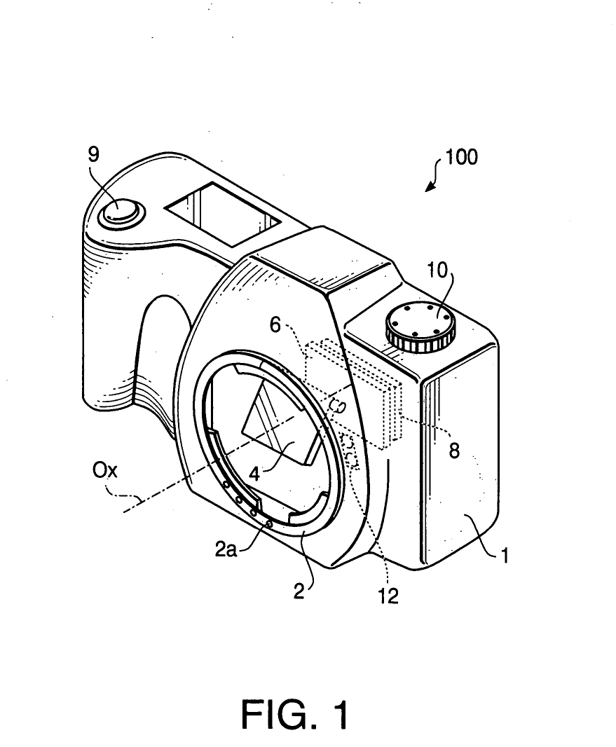

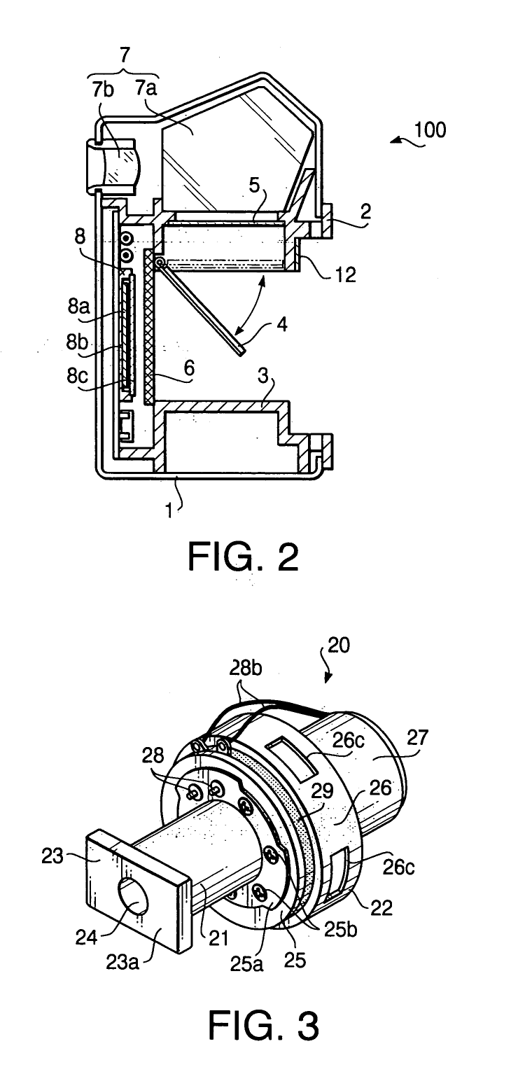

FIG. 1 shows an external view of a digital SLR camera 100 employing an interchangeable lens system, in accordance with an exemplary embodiment of this invention. On a front surface of a camera body 1, a lens mount 2 is provided. Via the lens mount 2, various interchangeable lenses (not shown) can be detachably attached to the camera body 1. In FIG. 1, Ox denotes an optical axis of the camera 100. The optical axis Ox is defined as an axis which coincides with an optical axis of the lens attached to the camera body 1. FIG. 2 shows a diagrammatic cross-sectional side view taken along the optical axis Ox of the camera 100. In the camera body 1, a mirror box 3 is defined. Inside the mirror box 3 is provided a movable mirror 4 that reciprocates in up-and-down direction, a focusing glass 5, and a shutter 6 are provided adjacently. The mirror box 3 is, as shown in FIGS. 1 and 2, exposed to outside through an opening defined by (i.e., surrounded by) the lens mount 2 when the lens is not attached to the camera body 1. Above the focusing glass 5, a finder optical system 7 including a pentaprism 7a and an eyepiece lens 7b is provided. Behind the shutter 6 (on a left-hand side of the shutter 6 in FIG. 2), an image sensing unit 8 is provided. The image sensing unit 8 captures an object image formed through a lens attached to the camera body 1, and outputs an image signal representing the captured image. The image sensing unit 8 contains an image sensor 8a which is comprised of a photoelectric converter, such as CCD or CMOS, in a package 8b. The image sensing unit 8a is enclosed by a cover glass 8c, which is arranged in front of the image capturing area of the image sensor 8a. In this digital SLR camera 100, when a shutter release operation is not being carried out, the movable mirror 4 is located at the lower position as drawn in solid lines, the shutter 6 is closed, and light passed through the lens is reflected in the mirror 4 and forms an image on the focusing glass 5, which image can be observed through the finder optical system 7. When the shutter release operation is being carried out, the movable mirror 4 is located at an uplifted position as drawn with double-dashed lines, the shutter 6 is opened, and light provided through the lens is incident on the image capturing area of the image sensor 8a inside the image sensing unit 8 to form the object image thereon. The image sensor 8a outputs photoelectrically converted image signals corresponding to the object image.

As shown in FIG. 1, at the top surface of the camera body 1, a release button 9 for the release operation described above and a mode dial 10 to switch among a plurality of operation modes are provided. In the camera 100 according to the embodiment, a cleaning mode is included in the plurality of operation modes. The cleaning mode is selected when the dirt and/or dust inside the camera body 1 is to be removed. The mode dial 10 is connected with an electrical circuit, which has a well-known configuration and description thereof is herein omitted. When the mode dial 10 is set to the cleaning mode, the movable mirror 4 is moved to the uplifted position, and the shutter 6 is opened. When the mode dial 10 is switched to another mode from the cleaning mode, the movable mirror 4 returns to the lower position, and the shutter 6 is closed. Inside the camera body 1, two cleaning electrode terminals 12 are provided. The cleaning electrode terminals 12 are used for supplying a prescribed voltage to a cleaning apparatus 20 (described later) when it is coupled to the camera body 1. The voltage output by the cleaning electrode terminals 12 is supplied by a battery (not shown) that is contained inside the camera body 1.

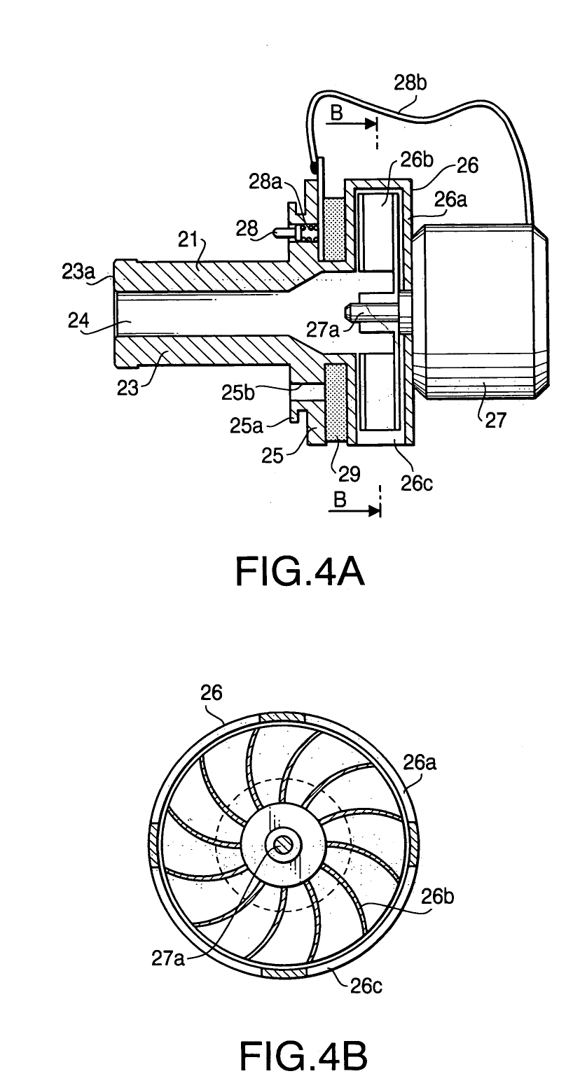

FIG. 3 is an external perspective view of the cleaning apparatus to be used in association with the digital SLR camera 100. FIG. 4A is a cross-sectional side view of the cleaning apparatus 20 taken along the central axis of the cleaning apparatus, and FIG. 4B is a cross-sectional view taken along line B-B of FIG. 4A. The cleaning apparatus 20 is configured to remove the dirt and/or dust adhered to the surface of cover glass 8c of the image sensing unit 8. The cleaning apparatus 20 is inserted inside the camera body 1 through the opening at the lens mount 2, and is equipped with an aspirator pipe 21 that allows air to flow therein, and an aspirator module 22 that is positioned behind the aspirator pipe 21. The aspirator pipe 21 is integrated with a rectangular head 23, which is inserted through an opening of the shutter 6 when the shutter 6 is opened and positioned to face the cover glass 8c of the image sensing unit 8. The rectangular head 23 is formed at least greater than the image capturing area of the image sensor 8a in shape and size, and a front end surface 23a thereof is flattened. The center of the front end surface 23a is provided with a circular aspirator opening 24, which communicates with the inside of the aspirator pipe 21. Further, at a base of the aspirator pipe 21, a circular flange 25 that directly abuts a mounting surface of the lens mount 2 is integrally formed. It is preferable the flange 25 is configured to be fixedly coupled to the lens mount 2. In the present embodiment, the flange 25 is provided with a bayonet piece 25a, which is similar to those provided to the interchangeable lenses, and the flange 25 is configured to be interlocked fixedly to the lens mount 2 by rotating the flange 25 by a small angle to engage the bayonet piece 25a with a bayonet groove formed on the lens mount 2.

When the rectangular head 23 of the aspirator pipe 21 is inserted into the camera body 1 through the opening of the lens mount 2, and the flange 25 is abutted onto the lens mount 2, the rectangular head 23 passes through the opened shutter 6 and is positioned such that the front end surface 23a faces the cover glass 8c. The length of the aspirator pipe 21 is designed to maintain a minute gap d between the front surface 23a and the cover glass 8c. The opening of the shutter 6 is formed to have a sufficient space that allows the rectangular head 23 to rotate together with the integrated aspirator pipe 21 when the flange 25 is coupled to the lens mount 2 by the bayonet piece 25a. Alternatively, the rectangular head 23 may be rotatably connected to the aspirator pipe 21 so that the flange 25 can be rotated when interlocked to the lens mount 2 with allowing the rectangular head 23 to be substantially fitted in the opening of the shutter 6.

The aspirator module 22 of the cleaning apparatus 20 is equipped with a turbo fan 26, which is integrated with the flange 25 at the proximal end of the aspirator pipe 21, and a motor 27 that drives the turbo fan 26. The turbo fan 26 has a fan room 26a, which is a cylindrical hollow space and communicates with the inside of the aspirator pipe 21, and rotary impeller 26b, which is installed on a rotary shaft 27a of the motor 27 and driven thereby. When the rotary impeller 26b is rotated, the air inside both the fan room 26a and the aspirator pipe 21 is ejected through exhaust outlets 26c, which are opened along the circumference of the fan room 26a.

The flange 25 is provided with, on the inner circumferential surface of the lens mount 2, two electrode pins 28, which are supported by springs 28a, respectively, and retractably protruded in the direction of the axis of the aspirator pipe 21, toward the shutter 6. When the flange 25 is mounted onto the lens mount 2, the electrode pins 28 resiliently contact the cleaning electrode terminals 12 provided in the camera body 1, respectively, and connected thereto electrically. The electrode pins 28 are electrically connected to the motor 27 through electric cords 28b, and a predetermined voltage is supplied to the motor 27 through the cleaning electrode terminals 12. The flange 25 is formed with a plurality of aspiration inlets 25b which are through openings penetrating the flange 25 in the thickness direction at positions along the outer diameter of the aspirator pipe 21. The plurality of aspiration inlets 25b make the inside of the camera body 1 communicate with the outside thereof when the flange 25 contacts the lens mount 2. Between the flange 25 and the fan room 26a of the turbo fan 26, an annular filter 29 is provided to filter the dirt and/or dust in the air that passes through the aspiration inlets 25b.

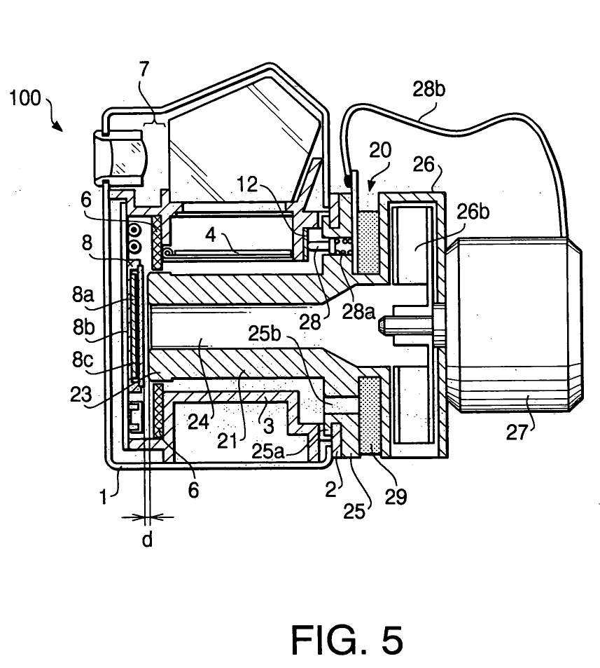

A method of cleaning the image sensing unit 8 inside the camera body 1 by use of the cleaning apparatus 20 configured as above will be described. FIG. 5 shows a cross-sectional side view of the cleaning apparatus 20 in use. When a lens (not shown) is removed from the camera body 1 and mode dial 10 is switched to the cleaning mode, the movable mirror 4 is moved to the uplifted position, while the shutter 6 is opened, and the cover glass 8c of the image sensing unit 8 behind the mirror box 3 is exposed. Further, the aspirator pipe 21 with the rectangular head 23 of the cleaning apparatus 20 is inserted into the camera body 1 through the opening of the lens mount 2. The flange 25 is positioned to the lens mount 2 and rotated by a predetermined small angle about the pipe axis. Then, the flange 25 is fixedly interlocked to the lens mount 2 by the bayonet piece 25a that is provided to the flange 25. When the cleaning apparatus 20 is coupled to the camera body 1 as above, the rectangular head 23 at the end of the aspirator pipe 21 is inserted through the mirror box 3 and the shutter 6, and its front end surface 23a is positioned to face the surface of the cover glass 8a of the image sensing unit 8 with a minute gap d therebetween. When the flange is rotated by a small angular amount for attachment, the rectangular head 23 is also rotated by the small angular amount. However, as described above, the allowance provided at the shutter 6 (or, in the alternative embodiment, the configuration that only the flange 25 is rotatable), the rectangular head 23 is located at the predetermined position in a predetermined orientation.

When the cleaning apparatus 20 is coupled to the camera body 1 as described above, the electrode pins 28 provided on the inner surface of the flange 25 resiliently and electrically contact the cleaning electrode terminals 12 provided on the outer surface of the lens mount 2. Thus, the predetermined voltage, which is supplied from the battery when the mode dial 10 is switched to the cleaning mode, is supplied from the cleaning electrode terminals 12 to the motor 27 through the electrode pins 28 and the electric cords 28b. With the voltage supplied, the motor 27 rotates, and ejects the air inside the fan room 26a through the exhaust outlets 26c as illustrated in dashed arrows. This evacuating operation generates negative pressure inside the aspirator pipe 21, and the air inside the camera body 1 is aspirated and ejected outside the camera body 1 as described above. In addition, inside the camera body 1 the outside air is aspirated through the aspiration inlets 25b, which is purified through the filter 29. This series of evacuating operation generates a centralizing air flow, on the cover glass 8c, from the periphery toward the center at the gap d between the rectangular head 23 and the front end surface 23a. The venturi effect caused by this air flow remarkably speeds up the current. The air flow unsticks and removes the dirt and/or dust adhered to the surface of the cover glass 8c, and thus the surface of the cover glass 8c is cleaned. The air flow also ejects the dirt and/or dust floating inside the camera body 1.

After the cleaning is accomplished, when the cleaning apparatus 20 is detached from the camera body 1 and the mode dial 10 is switched from the cleaning mode to another mode, the shutter 6 is closed, and the movable mirror 4 is returned to the lower position. When the movable mirror 4 is located at the lower position, the interior of the mirror box 3 is still exposed to outside through the opening of the lens mount 2. However, the surface of the cover glass 8c is blocked by the shutter 6, and therefore separated from the interior of the mirror box 3. This configuration prevents additional dirt and/or dust from adhering to the surface of the cover glass 8c.

In the embodiment described above, the movable mirror 4 is moved to the uplifted position and the shutter 6 is opened when the camera 100 operates in the cleaning mode. It is possible that the cleaning mode may be substituted by the “bulb” setting of the shutter speed. In the bulb setting, the movable mirror 4 is uplifted and the shutter 6 is opened while the release button 9 is being depressed. In this case, however, the release button 9 must remain depressed during the cleaning. In regard to this inconvenience, configuring the cleaning mode as described above suggests a more effortless method of cleaning without requiring continuous depression of the release button 9.

In the above embodiment, since the motor 27 is used for aspirating, it is possible that the cleaning apparatus 20 generates a high-speed continuous air current so that the dirt and/or dust is effectively removed. In addition, the cleaning apparatus 20 is not required to be equipped with a dedicated independent battery, as the motor 27 utilizes the battery built in the camera body 1, and therefore the cleaning apparatus 20 may remain downsized. Further, the cleaning operation does not produce vibration in the camera 100, and therefore the awkwardness caused by the vibration is avoided. Also, the cleaning operation is performed without contacting the cleaning device 20 with the surface of the cover glass 8c, and therefore, the cover glass 8c will not be damaged by the cleaning device 20.

### Second Embodiment

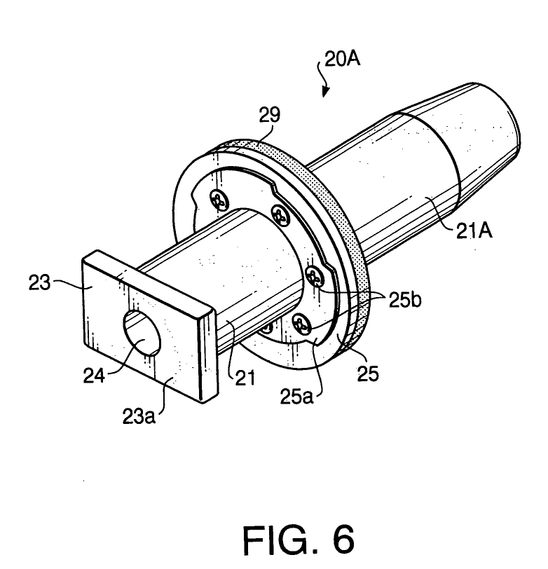

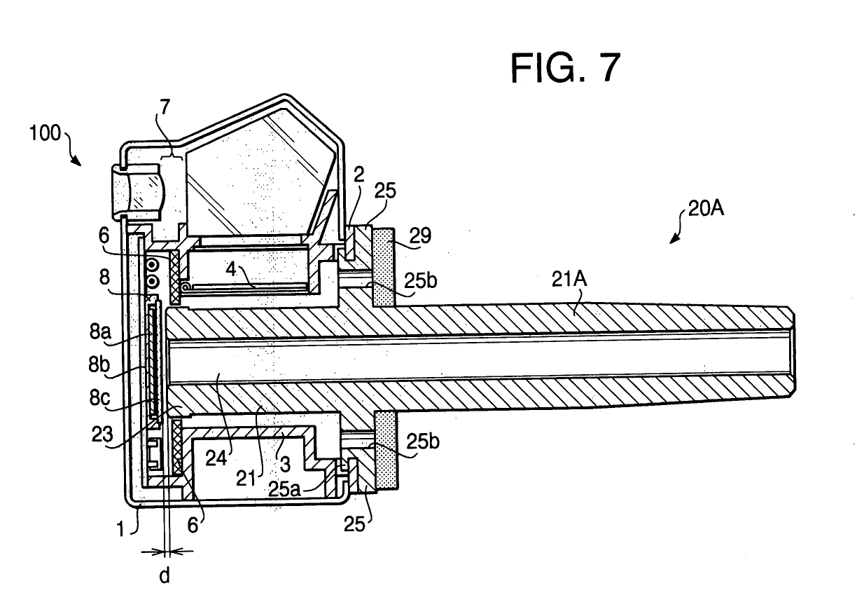

FIG. 6 is a perspective view showing an appearance of a cleaning apparatus 20A according to a second embodiment, and FIG. 7 is a cross-sectional view of the cleaning apparatus 20A in use. In this embodiment, the cleaning apparatus 20A is configured to remove the dirt and/or dust adhered to the cover glass 8c of the image sensing unit 8 by manually aspirating the air inside the camera body 1. It should be noted that the cleaning apparatus 20A has a simplified configuration compared to the cleaning device 20 according to the first embodiment. In FIG. 6 and FIG. 7, the components equivalent to those shown in the first embodiment are assigned with the identical reference numerals as in the first embodiment. In this embodiment, a rectangular head 23 is provided at the end of an aspirator pipe 21, and the apical area 23a is provided with a circular aspiration opening 24 that communicates with the inside of the aspirator pipe 21. Further, the base of the aspirator pipe 21 is provided with a flange 25. Similar to the first embodiment, the flange 25 is formed with bayonet piece 25a and aspiration inlets 25b, and equipped with a filter 29. In the second embodiment, at the base of the aspirator pipe 21, only a hollow cylindrical aspirator tube 21A is integrally formed, and an aspiration apparatus is provided separately. As described below, a manually operable aspiration apparatus is configured to be connected with the aspirator tube 21A.

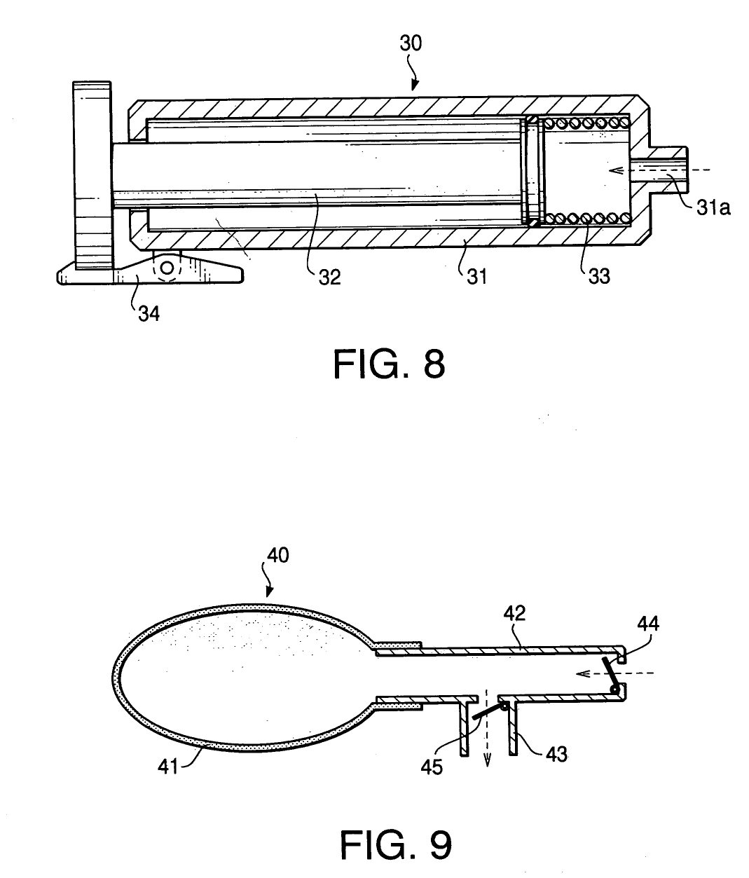

A manually operable (non-electric) aspiration apparatus that is connected to the aspirator tube 21A may be, for example, a pump aspirator 30 as illustrated in FIG. 8. Like a syringe, the pump aspirator 30 contains a plunger 32, which is reciprocative in the axial direction, inside the outer tube 31 formed with an aspirating opening 31a. The air is aspirated inside the outer tube 31 when the plunger 32 is pulled out (i.e., moved to a left-hand side in FIG. 8) with respect to the outer tube 31. The pump aspirator 30 is equipped with a spring 33 that applies an expanding force to move the plunger 32 in a direction away from the aspirating opening 31a. Further, the pump apparatus 30 is provided with a latch 34 that clasps the plunger 32 to prevent the plunger 32 from sliding out unexpectedly. As the pump aspirator, a desolder pump that is used for removing excess solder may be utilized.

The pump aspirator 30 is connected directly or through a flexible member such as a rubber tube to the aspirator tube 21A of the cleaning apparatus 20. As illustrated in FIG. 7, by setting the camera body 1 in the cleaning mode, the movable mirror 4 is moved to the uplifted position and the shutter 6 is opened. The aspirator pipe 21 is inserted into the camera body 1. In this event, the flange 25 is fixedly interlocked to the lens mount 2 preferably utilizing the bayonet piece 25a, and the rectangular head 23 is positioned to face the surface of the cover glass 8c of the image sensing unit 8 with a slight gap d therebetween. Furthermore, when the plunger 32 becomes free by releasing the latch 34, the plunger 32 slides outward by the force applied by the spring 33, and the air is aspirated through the opening 31a. Through this operation, similarly to the first embodiment, the air inside the camera body 1 is ejected through the aspirator pipe 21 of the cleaning apparatus 20A, and thus due to the air current generated at the gap d between the front end surface 23a of the rectangular head 23 and the cover glass 8c, the dirt and/or dust adhered to the cover glass 8c is removed.

Alternatively, as another manual aspiration measure, a blower aspirator 40 as illustrated in FIG. 9 may be used. The blower aspirator 40 is configured with an air pump 41 formed from rubber or flexible plastic and a pipe 42 provided at an opening of the air pump 41. The air pump 41 may be compressed by hand, and may return to the initial shape by its own elasticity, which causes the air inside to discharge and the ambient air to enter. The pipe 42 is provided with a diverging outlet 43, and an exhaust valve 45 is provided inside the diverging outlet 43. The exhaust valve 45 only allows the air in the blower aspirator 40 to discharge. Also, an aspirator valve 44 is provided inside the pipe 42, which only allows the air to be aspired from the ambient.

The blower aspirator 40 is connected directly or through a flexible member such as rubber tube to aspirator tube 21 of the cleaning apparatus 20. As illustrated in FIG. 7, by setting the camera body 100 in the cleaning mode, the movable mirror 4 is uplifted and the shutter 6 is opened. The rectangular head 23 is inserted into the camera body 1. In this event, the aspirator pipe 21 is configured to rotate on the axis apart from the rectangular head 23, as this configuration allows the rectangular head 23 to be located in the predetermined position, as described in the first embodiment. In accordance with the above configuration, the air pump 41 is compressed to eject the air inside the air pump 41 through the diverging outlet 43, and is successively released to return in the initial shape, thereby the ambient air flows into the air pump 41 through the tube 42. This flow causes aspiration of the air inside the camera body 1 through the aspirator pipe 21 of the cleaning apparatus 21A. In the camera body 1, the air current generated at the gap d between the front end surface 23a of the rectangular head 23 and the surface of the cover glass 8c removes the dirt and/or dust adhered to the cover glass 8c.

In the second embodiment, the aspiration of the cleaning apparatus 20A to eject/inject the air from/in the camera body 1 is operated manually (i.e., non-electrically), therefore a motor or electric cords and electrodes to drive a motor are unnecessary, and this allows the cleaning apparatus downsized and downscaled in price. In addition, the camera body 1 is not required to be equipped with the cleaning electrode terminals 12, in case the camera 100 is dedicated to the cleaning apparatus according to the second embodiment.

In the cleaning apparatus according to each embodiment, the rectangular head 23 is provided with one circular aspirator opening 24 that communicates with the aspirator pipe 21. It should be noted, however, that more than one aspirator opening may be provided at balanced points of the front end surface facing the cover glass 8c of the image sensing unit 8, where each opening communicates with the inside of the aspirator pipe 21. It is preferable that the locations of these openings are adjusted considering and calculating the speed of the air current generated between the cover glass 8c and the rectangular head 23 in regard to the aspirating capability.

In each embodiment described above, the bayonet piece 25a is provided to the flange 25 of the cleaning apparatus in order to attach the cleaning apparatus fixedly to the camera body 1. However, cleaning may be performed sufficiently by pressing the flange 25 of the cleaning apparatus closely onto the lens mount 2, and thus the configuration of the cleaning apparatus becomes even more simplified.

In addition, in the first embodiment, the cleaning electrode terminals 12 are equipped in the camera body 1 to supply power to the cleaning apparatus, however, existing lens information contacts 2a (refer to FIG. 1) that are provided on the lens mount 2 to exchange information electrically between the camera body and the lens may be utilized for power supply.

The present disclosure relates to the subject matter contained in Japanese Patent Application No. 2004-172043, filed on Jun. 10, 2004, which is expressly incorporated herein by reference in its entirety.

1. A digital camera employing an interchangeable lens system allowing a plurality of lenses to be selectively and detachably attached to a lens mount provided to a camera body, the digital camera comprising:
an image sensor that captures an optical image of an object formed by a lens attached to the camera body;
a plurality of movable members being arranged between the lens mount, the plurality of movable members moving when an image is captured;
an operable member allowing a user to select one of a plurality of operation modes of the digital camera, the plurality of operation modes including at least a cleaning mode; and
a controller that drives the movable members to be retracted from a path from the lens mount to the image sensor to allow access to the image sensor from the lens mount when the cleaning mode is selected by the operable member.

2. The digital camera according to claim 1,
wherein the digital camera is a digital single-lens reflex camera;
wherein the movable members include a quick return mirror and a shutter; and
wherein the controller moves the quick return mirror to a lifted position and maintains the shutter in an opened status when the cleaning mode is selected.

3. The digital camera according to claim 1, wherein the camera body is provided with electrodes that supply electrical power when the cleaning mode is selected.

4. A cleaning apparatus that removes dirt and/or dust adhered to an image capturing area of an image sensor arranged inside a camera body, the camera body having a lens mount to which a plurality of exchangeable lenses are selectively and detachably mounted, the cleaning apparatus being detachably mounted to the lens mount, the cleaning apparatus comprising:
a cleaning head having a front end surface that faces the image capturing area of the image sensor when the cleaning apparatus is mounted on the lens mount;
an opening formed on the front end surface of the cleaning head; and
an aspirator pipe connected to the opening formed on the front end surface of the cleaning head, the air being ejected from the camera body to outside through the aspirator pipe.

5. The cleaning apparatus according to claim 4, further including an aspirating apparatus that aspirates the air inside the camera body through the aspirator pipe.

6. The cleaning apparatus according to claim 5, wherein the aspirating apparatus is an electrically operable apparatus, an electrical power being supplied to the aspirating apparatus from the camera body.

7. The cleaning apparatus according to claim 4, wherein the front end surface faces the image capturing area of the image sensor with a minute gap there between.

8. The cleaning apparatus according to claim 4, wherein the front end surface has an area that is greater than the image capturing area of the image sensor.

9. The cleaning apparatus according to claim 4, further including a flange portion formed around the aspirator pipe, the flange portion contacting the lens mount when the cleaning apparatus is coupled to the camera body, the flange portion restricting an inserting amount of the cleaning head in the camera body.

10. The cleaning apparatus according to claim 9, wherein the flange portion is formed with at least one inlet opening that allows the air to be introduced inside the camera body, the cleaning apparatus including a filter that filters the air introduced from the at least one inlet opening, the air filtered by the filter being introduced in the camera body.

11. The cleaning apparatus according to claim 5, where the aspirating apparatus is an non-electrically operable apparatus which is manually operated by a user.

12. A digital camera system including a digital camera and a cleaning apparatus, the digital camera employing an interchangeable lens system allowing a plurality of lenses to be selectively and detachably attached to a lens mount provided to a camera body,
wherein the digital camera comprises:
an image sensor that captures an optical image of an object formed by the lens attached to the camera body;
a plurality of movable members being arranged between the lens mount, the plurality of movable members moving when an image is captured;
an operable member allowing a user to select one of a plurality of operation modes of the digital camera, the plurality of operation modes including at least a cleaning mode; and
a controller that drives the movable member to be retracted from a path from the lens mount to the image sensor to allow an access to the image sensor from the lens mount when the cleaning mode is selected by the operable member, and
wherein the cleaning apparatus comprises:
a mounting mechanism that allows the cleaning apparatus to be mounted on the lens mount;
a cleaning head having a front end surface that faces the image capturing area of the image sensor when the cleaning apparatus is mounted on the lens mount;
an opening formed on the front end surface of the cleaning head; and
an aspirator pipe connected to the opening formed on the front end surface of the cleaning head, the air being ejected from the camera body to outside through the aspirator pipe.

13. The camera system according to claim 12, wherein the cleaning apparatus further includes an aspirating apparatus that aspirates the air inside the camera body through the aspirator pipe.

14. The camera system according to claim 13,
wherein the aspirating apparatus is an electrically operable apparatus,
wherein the camera body is provided with first electrodes that supply electrical power when the cleaning mode is selected,
wherein the aspirating apparatus is provided with second electrodes which contact the electrodes provided to the camera body when the cleaning apparatus is mounted on the camera body, an electrical power being supplied to the aspirating apparatus from the camera body through the first and second electrodes.

15. The camera system according to claim 13, where the aspirating apparatus is an non-electrically operable apparatus which is manually operated by a user.

16. The camera system according to claim 12, wherein the front end surface faces the image capturing area of the image sensor with a minute gap there between.

17. The camera system according to claim 12, wherein the front end surface has an area that is greater than the image capturing area of the image sensor.

18. The cleaning apparatus according to claim 12, the cleaning apparatus including a flange portion formed around the aspirator pipe, the flange portion contacting the lens mount when the cleaning apparatus is coupled to the camera body, the flange portion restricting an inserting amount of the cleaning head in the camera body.

19. The camera system according to claim 18, wherein the flange portion is formed with at least one inlet opening that allows the air to be introduced inside the camera body, the cleaning apparatus including a filter that filters the air introduced from the at least one inlet opening, the air filtered by the filter being introduced in the camera body.
